(19) United States
(12) Patent Application Publication
(10) Pub. No.: US 2003/0070891 A1
(43) Pub. Date: Apr. 17, 2003

(54) Molded article of metal matrix composite and method for making such an article

(75) Inventors: Yasuhiro Nakao, Sayama-shi (JP); Hiroto Shoji, Sayama-shi (JP); Kunitoshi Sugaya, Sayama-shi (JP); Takashi Kato, Sayama-shi (JP); Takaharu Echigo, Sayama-shi (JP)

Correspondence Address: MERCHANT & GOULD PC, P.O. BOX 2903, MINNEAPOLIS, MN, 55402-0903, US

(73) Assignee: Honda Giken Kogyo Kabushiki Kaisha, Tokyo (JP)

(21) Appl. No.: 10/301,202

(22) Filed: Nov. 20, 2002

Related U.S. Application Data
(62) Division of application No. 09/569,190, filed on May 11, 2000.

(30) Foreign Application Priority Data
May 11, 1999 (JP) 11-130516
May 11, 1999 (JP) 11-130523

(51) Int. Cl. F16D 65/10

(52) U.S. Cl. 188/218 XL

(57) ABSTRACT

A molded brake disc having a central hub portion and an annular disc portion extending from the hub portion in a radial outward direction for frictional engagement with brake pads, wherein the disc portion is formed of metal matrix composite having a reinforcing material added to a metal matrix, and the hub portion is formed of metal which is inexpensive as compared to the metal matrix composition. Due to a limited use of the expensive metal matrix composite, the molded brake disc as a whole is inexpensive as compared to a conventional molded brake disc entirely formed of metal matrix composite. Such molded brake disc can readily be formed by an improved injection molding method, wherein a metal matrix composite material in a molten state and a metallic material in a semi-solidified state are supplied into an injection cylinder such that the metal matrix composite material is situated on a gate side adjacent to a gate of a molding die and the metallic material is situated on a piston side adjacent to a piston in the injection cylinder, and the metal matrix composite material and the metallic material are then forced by the piston into a die cavity in the molding die in the order named.

### BACKGROUND OF THE INVENTION

1. Field of the Invention

The present invention relates to a molded article of metal matrix composite (MMC) and a method for making such an article through an injection molding process.

2. Description of the Related Art

FIG. 10 shows a typical example of conventional disc brakes for automobiles. The disc brake 102 includes a hub 101 mounted to a drive shaft 100, a disc rotor 103 attached to the hub 101, and a caliper 106 disposed astride the disc rotor 103. When the driver steps on the brake pedal, hydraulic pressure pushes on pistons (not shown) inside the caliper 108 and it pushes brake pads 107, 107 against a annular disc portion 105 of the rotating disc rotor 103 to slow down or stop rotation of a wheel 109.

Since the disc portion 105 of the disc rotor 103 provides pad rubbing areas which are subjected to frequent frictional engagement with the brake pads 107, 107, high-mechanical-strength materials are required for the disc rotor 103. In addition, in order to reduce the body weight of an automobile, the disc rotor 103 is preferably formed of lightweight materials.

Metal matrix composites (MMCs) are known as a high-mechanical-strength, light-weight material. Among others, an MMC having a metal matrix formed from an aluminum alloy and containing silicon carbide particles dispersed in the aluminum alloy matrix is particularly advantageous because the aluminum alloy matrix offers a considerable reduction in weight and the silicon carbide particles exhibit a particularly high mechanical strength.

A conventional method for making the disc rotor 103 using the MMC with aluminum alloy matrix will be described with reference to FIG. 11. As shown, for carrying out the method, an injection molding machine widely used in the molding industries is provided. The injection molding machine includes a molding die composed of a movable die 110 and a stationary or fixed die 111 jointly defining a die cavity 112, an injection cylinder 115 disposed in fluid communication with the die cavity 113 through a gate 113 formed in the fixed die 111, a piston 115 slidably disposed inside the injection cylinder 115, an MMC feed unit 118 connected with the injection cylinder 115 via an MMC feed path 117, and an shutoff valve 119 disposed across the feed path 117 at a position near an outlet of the feed path 117.

At first, the die cavity 112 is closed and while keeping this condition, the shut-off valve 119 is opened. Then, a desired quantity of aluminum-based MMC material (including an aluminum alloy matrix and silicon carbide particles dispersed in the matrix) is supplied in a molten or liquid state from the MMC feed unit 118 into the injection cylinder 115, as indicated by the arrow shown in FIG. 11. Subsequently, the piston 116 is advanced (or moved upward as indicated by the profiled arrow in FIG. 11) to force the molten MMC material through the gate 113 into the die cavity 112. After a pre-set dwell time for curing or solidification, the movable die 110 is moved upward as indicated by the profiled arrow to open the die cavity 112 and a molded article is removed from the die cavity 112.

The molded article 120, as shown in FIG. 12, includes a product part (cavity portion) 121 corresponding in contour to the shape of the die cavity 112, and a non-product part (gate portion) 122 corresponding in contour to the shape of the gate 113. In FIG. 12, these parts 121, 122 are shown in separated condition for the purpose of illustration, but they are integral until the gate portion 122 is removed.

The product part (cavity portion) 121 is formed from aluminum-based MMC and is subsequently finished into the shape of a disc rotor 10 shown in FIG. 10 through appropriate working processes. The non-product part (gate portion) 122 is also formed from aluminum-based MMC and is subsequently cut off or removed from the product part 121. It is preferable that the removed non-product part 122 can be recycled. However, due to the presence of the silicon carbide particles dispersed in the aluminum alloy matrix, the non-product part 122 cannot be recycled unless the silicon carbide particles are completely separated from the aluminum alloy matrix. Such a separation is, however, practically impossible to achieve because it involves certain technological difficulties and requires undue high cost. Thus, notwithstanding the fact that the MMC material is relatively expensive, the non-product part 122 is disposed as a waste. This may lead to an increased manufacturing cost of the final product (disc rotor) 103.

### SUMMARY OF THE INVENTION

It is, therefore, an object of the present invention to provide a molded article of MMC which is relatively inexpensive to manufacture and has a desired high mechanical strength.

Another object of the present invention is to provide an injection molding method which can produce a molded article of MMC at a relatively low cost.

A further object of the present invention is to provide an injection molding method which is particularly suitable for forming a molded article having two adjoining parts one of which is required to possess a higher mechanical strength than the other part.

According to a first aspect of the present invention, there is provided a molded article having two parts adjoining with each other, one of the two parts being required to have a higher mechanical strength than the other part, wherein the one part is formed of a metal matrix composite material, and the other part is formed of a metallic material, the metal matrix composite material and the metallic material being united together at a boundary between the two parts.

In one preformed form, the molded article is comprised of a brake disc of a disc brake, wherein the one part of the molded article is an annular disc portion of the brake disc including a pad rubbing area provided for frictional engagement with a brake pad of the disc brake.

Due to a limited use of the metal matrix composite material which is relatively expensive, the molded article such as a brake disc is inexpensive to manufacture but can retain a desired degree of mechanical strength.

According to another aspect of the present invention, there is provided a method of forming a molded article on an injection molding apparatus using a metal matrix composite material, the injection molding apparatus including a molding die having a die cavity defined therein, an injection cylinder communicating with the die cavity via a gate formed in the molding die, and a piston slidably disposed inside the injection cylinder for reciprocating movement toward and away from the gate of the molding die, the method comprising the steps of:

supplying a desired quantity of metallic material in a semi-solidified state and a desired quantity of metal matrix composite material in a molten state into the injection cylinder in such a manner that the semi-solidified metallic material is situated on a piston side adjacent to the piston and the molten metal matrix composite material is situated on a gate side adjacent to the gate; and

subsequently advancing the piston toward the gate to force the molten metal matrix composite material and the semi-solidified metallic material into the die cavity in the order named, whereby the metal matrix composite and the metallic material are formed into a shape complementary in contour to the die cavity.

In the method used for forming a molded article having two adjoining parts with one part having a higher mechanical strength than the other part, the desired quantity of metal matrix composite material is substantially equal to a cubic volume of the one part of the molded article, and the desired quantity of metallic material is substantially equal to the sum of a cubic volume of the other part of the molded article and a cubic capacity of the gate.

Since at least a gate portion of the molded article is formed of metallic material which is inexpensive as compared to the metal matrix composite material, and since the gate portion formed of metallic material can readily be recycled, the molded article can be manufactured less costly while maintaining a desired high mechanical strength.

The above and other objects, features and advantages of the present invention will become manifest to those versed in the art upon making reference to the following description and accompanying sheets of drawings in which preferred structural embodiments incorporating the principle of the invention are shown by way of illustrative examples.

### BRIEF DESCRIPTION OF THE DRAWINGS

FIG. 1 is a perspective view of a brake disc or rotor of a disc brake formed by an injection molding method using an MMC material according to the present invention;

FIG. 2 is a cross-sectional view taken along line II-II of FIG. 1;

FIG. 3 is a diagrammatical cross-sectional view of an injection molding apparatus used for carrying out the injection molding method of the present invention;

FIGS. 4A and 4B are views similar to FIG. 3, showing the manner in which a material feeding process is achieved in accordance with the injection molding method;

FIGS. 5A and 5B are views similar to FIG. 3, showing the manner in which an material injecting process is achieved in accordance with the injection molding method;

FIG. 6 is a view similar to FIG. 3, showing the manner in which a molded article is removed from a molding die;

FIG. 7 is a perspective view of a modified brake disc or rotor formed by the injection molding method according to the present invention;

FIG. 8 is a view corresponding to FIG. 5B, showing a material injecting process achieved to produce the brake disc shown in FIG. 7;

FIG. 9 is a schematic cross-sectional view of a molded article formed after the material injecting process shown in FIG. 8;

FIG. 10 is a cross-sectional view showing a typical example of conventionally used disc brakes for automobiles;

FIG. 11 is a diagrammatical cross-sectional view showing an injection molding apparatus used for forming a brake disc of the disc brake shown in FIG. 10: and

FIG. 12 is a schematic cross-sectional view showing a molded article as it is removed from a molding die of the injection molding apparatus shown in FIG. 11.

### DETAILED DESCRIPTION OF THE PREFERRED EMBODIMENTS

Certain preferred embodiments of the present invention will be described below in greater detail with reference to the accompanying sheets of drawings wherein like or corresponding parts are designated by the same reference characters throughout several views.

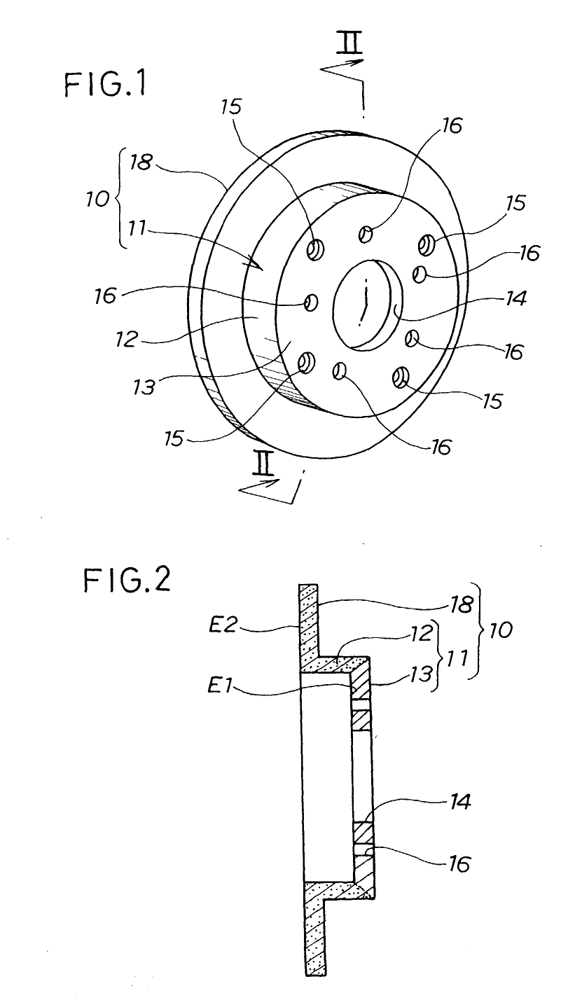

Referring now to FIG. 1, there is shown in perspective a brake disc or rotor of a disc brake formed by injection molding using an MMC material according to one embodiment of the present invention.

The brake disc 10 has a generally hat-like configuration including a cup-like central portion (hub portion) 11 and an annular disc portion 18 formed integrally with the hub portion 11.

The hub portion 11 includes a tubular peripheral wall 12 and a circular end wall 13 formed integrally with one end of the peripheral wall 12. The end wall 13 has a central hole or opening 14, a plurality of bolt holes 15 and a plurality of stud holes 16 arranged around the central opening 14 in concentrical that are arranged concentrically at equal angular intervals about the center of the opening 14.

Though not shown, bolts are inserted in the bolt holes 15 of the hub portion 11 to attach the brake disc 10 to a drive shaft side. Similarly, wheel studs are press-fitted in the stud holes 16 so that a wheel can be bolted to the brake disc 10.

The disc portion 18 has on its opposite surfaces pad rubbing areas which are adapted to be gripped by brake pads (not shown) of a caliper (not shown) disposed astride the brake disc 10, and so this portion 18 requires a high mechanical strength and an excellent wear resistance. Thus, the disc portion 18 is preferably formed solely of an MMC material. In the illustrated embodiment, the MMC material has an aluminum alloy matrix and silicon carbide particles dispersed in the aluminum alloy matrix as a reinforcing material. The MMC of this type is generally called “dispersion reinforced alloy”. Unlike the disc portion 18, the hub portion 11 does not require such a high mechanical strength and an excellent wear resistance because this portion is merely attached to the drive shaft side and free from abrasive wear caused due to frequent frictional engagement with the brake pads. Thus, at least the end wall 13 of the hub portion 11 is formed solely of an aluminum alloy which is inexpensive as compared to the aluminum-based MMC material. As shown in FIG. 2, the brake disc 10 has a first part E1 formed of aluminum alloy (corresponding to the hub end wall 13) and a second part E2 formed of aluminum-based MMC (corresponding to the disc portion 18). At a boundary between the two parts E1 and E2, the aluminum alloy and the aluminum-based MMC material are united together.

The brake disc 10 shown in FIGS. 1 and 2 are formed by injection molding as described below.

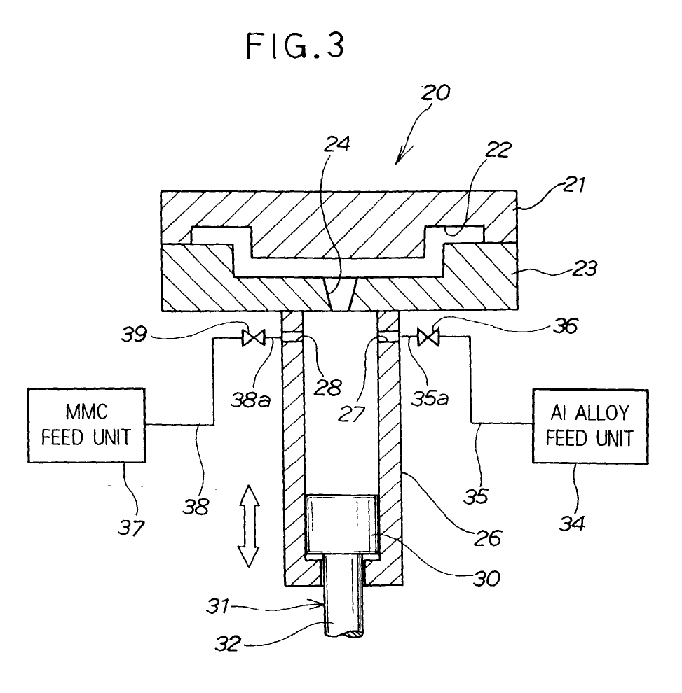

As shown in FIG. 3, an injection molding apparatus 20 used for carrying out the injection molding method of the present invention generally comprises a molding die composed of a movable die 21 and a fixed die 23 jointly defining therebetween a die cavity 22, an injection cylinder 26 attached to the fixed die 23, a piston 30 reciprocally movably received in the injection cylinder 26, an aluminum alloy feed unit 34 for supplying a desired quantity of aluminum alloy through an aluminum alloy supply passage or line 35 into the injection cylinder 26, and an MMC feed unit 37 for supplying a desired quantity of MMC material through an MMC supply passage or line 38 into the injection cylinder 26. The aluminum alloy supply line 35 is provided with a first shutoff valve 36 located near an outlet 35a of the supply line 35. Similarly, the MMC supply line is provided with a second shutoff valve 39 located near an outlet 38a of the supply line 38.

The injection molding apparatus 20 is of the vertical type wherein the movable die 21 is vertically movable relative to the fixed die 23, and the injection cylinder 26 is disposed vertically.

The fixed die 23 is formed with a gate 24 through which the die cavity 22 and the hollow interior (injection chamber) of the injection cylinder 26 communicate with each other. The term “gate” as used herein encompasses a sprue, a gate, a runner and so forth which form a non-product part of a molded article.

The piston 30 is slidably received in the injection cylinder 26 and has one end connected to an end of a rod 332 of a cylinder unit 31. When the cylinder unit 31 is operated to extend and contact the rod 32, the piston 30 reciprocates within the injection cylinder 26 as indicated by the profiled arrow shown in FIG. 3 so that an aluminum-based MMC material and an aluminum alloy fed into the injection cylinder 26 can be forced or injected into the die cavity 22 through the gate 24, as described below. The piston 30 is normally disposed in a retracted position which is located remotely from the gate 24, as shown in FIG. 3.

The aluminum alloy feed unit 34 is constructed to supply a desired quantity of aluminum alloy in a semi-solidified state into the injection cylinder 26 while the shut-off valve 36 is open.

Similarly, the MMC feed unit 37 is constructed to supply a desired quantity of aluminum-based MMC material (containing silicon carbide particles added or dispersed in an aluminum alloy matrix) in a molten or liquid state into the injection cylinder 26 while the shut-off valve 39 is open.

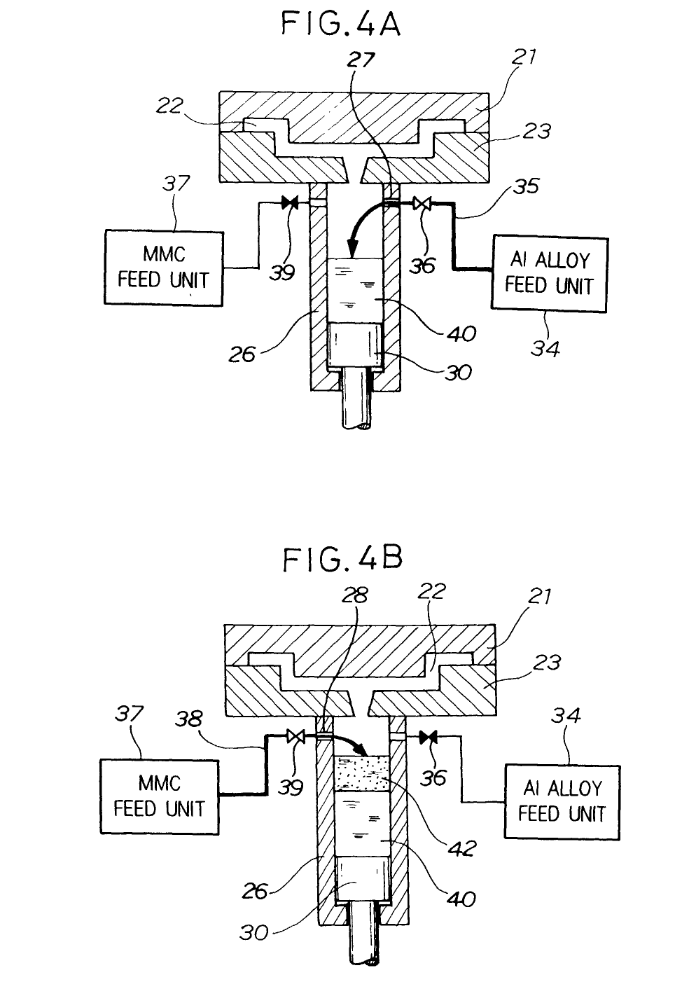

Turning now to FIGS. 4 through 6 inclusive, there is shown a sequence of operations achieved on the injection molding apparatus 20 for carrying out the injection molding method of the present invention. In these figures, the shutoff valves 36, 39 are dark-shaped when they are in a closed position.

As shown in FIG. 4A, the second shut-off valve 39 is closed and the first shut-off valve 36 is open, then a desired quantity of aluminum alloy 40 is supplied in a semi-solidified state from the aluminum alloy feed unit 34 through the aluminum alloy supply line 35 into the injection cylinder 26, as indicated by the arrow shown in this figure. In this instance, the quantity of supplied aluminum alloy is set to be substantially equal to the sum of a cubic capacity of the gate 24 (FIG. 3) and a cubic volume of an end wall of the hub of a brake disc blank (namely, a product part of a molded article).

Then, as shown in FIG. 4B, the first shut-off valve 36 is closed and the second shut-off valve 39 is opened, and after that a desired quantity of aluminum-based MMC material 42 is supplied from the MMC feed unit 37 through the MMC supply line 38 into the injection cylinder 26. In this instance, the quantity of supplied aluminum-based MMC material is set to be substantially equal to the sum of a cubic volume of a disc portion 18 of the brake disc blank and a cubic volume of a peripheral wall of the hub of the brake disc blank. The supplied aluminum-based MMC material quantity can be also determined by subtracting a cubic volume of the end wall of the brake disc blank from the cubic capacity of the die cavity 22.

Since the aluminum alloy 40 is supplied in a semi-solidified state and the aluminum-based MMC material 42 is supplied in a molten state, the aluminum-based MMC material 42 is placed on the aluminum alloy 40 in a separated condition. Within the injection cylinder 26, the aluminum alloy 40 is situated on a piston side adjacent to the piston 30 and the aluminum-based MMC material 42 is situated on a gate side adjacent to the gate 24 (FIG. 3).

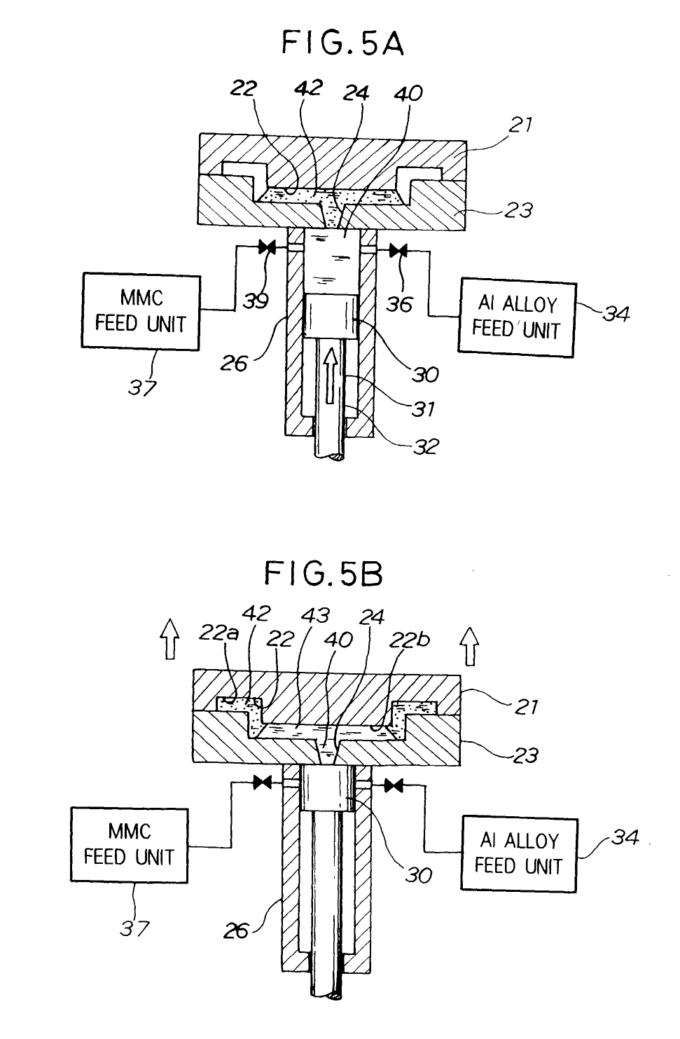

Subsequently, as shown in FIG. 5A, the second shut-off valve 39 is closed and the rod 32 of the cylinder unit 31 is extended to advance the piston 30 upward toward the fixed die 23 as indicated by the profiled arrow whereupon the semi-solidified aluminum alloy 40 is forced to move upward, thereby forcing the molten aluminum-based MMC material 42 to pass through the gate 24 and then enter the die cavity 22.

A further upward movement of the piston 30 causes the semi-solidified aluminum alloy 40 to move across the gate 24 and then enter the die cavity 22, whereby the molten aluminum-based MMC material 42 which is already existing inside the die cavity 22 is forced by the aluminum alloy 40 to flow in a radial outward direction to thereby fill in an annular disc portion 22a of the die cavity 22. When the piston 30 comes in contact with a lower surface of the fixed die 23, as shown in FIG. 5B, a hub end wall portion 22b of the die cavity 22 and the gate 24 are filled with the aluminum alloy 40. In this instance, respective positions of the aluminum-based MMC material 42 and aluminum alloy 40 correspond to the positions of the second and first parts E2 and El of the brake disc 10 shown in FIG. 2. The aluminum-based MMC material 42 and the aluminum alloy 40 are united together at a boundary therebetween.

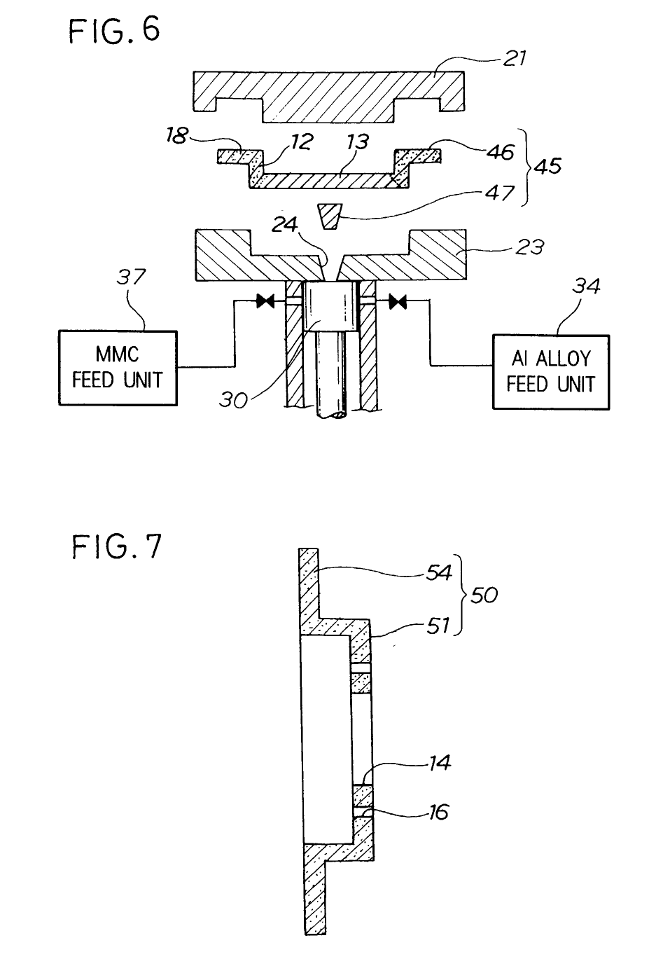

After a pre-set dwell time for solidification, the movable die 21 is moved upward away from the fixed die 23 to open the die cavity 22 and a molded article 45 is removed from the die cavity 22, as shown in FIG. 6. Subsequently, a non-product part (gate portion) 47 of the molded article 45 is cut-off or removed from a product part (cavity portion) 46 of the molded article 45. The product part 46 is subsequently finished into a brake disc 10 shown in FIGS. 1 and 2 through appropriate working processes.

The non-product part 47 is formed solely of the aluminum alloy and can readily be recycled by being melted down in the aluminum alloy feed unit 34. With this recycling of the aluminum alloy, the manufacturing cost of the brake disc 10 can be reduced.

Turning now to FIG. 7, there is shown a brake disc 50 formed by injection molding using an aluminum-based MMC material according to another embodiment of the present invention. The brake disc 50 has a hat-like configuration including a generally cup-like hub portion 51 and an annular disc portion 54 formed integrally with each other. Unlike the brake disc 10 of the first embodiment shown in FIGS. 1 and 2, the brake disc 50 as a whole is formed solely of an MMC material.

To form the brake disc 50, the injection molding apparatus 20 shown in FIG. 3 is also used.

Firstly, a semi-solidified aluminum alloy 40 and a molten aluminum-based MMC material 42 are supplied respectively from the aluminum alloy feed unit 34 and the MMC feed unit 37 into the injection cylinder 20 in the same manner as done in the first embodiment described previously with reference to FIGS. 4A and 4B. In this instance, the quantity of supplied aluminum alloy 40 is set to be slightly greater than the cubic capacity of the gate 24, and the quantity of supplied aluminum-based MMC material 42 is set to be substantially smaller than the cubic capacity of the die cavity 22. Then, the first and second shut-off valves 36, 39 are closed.

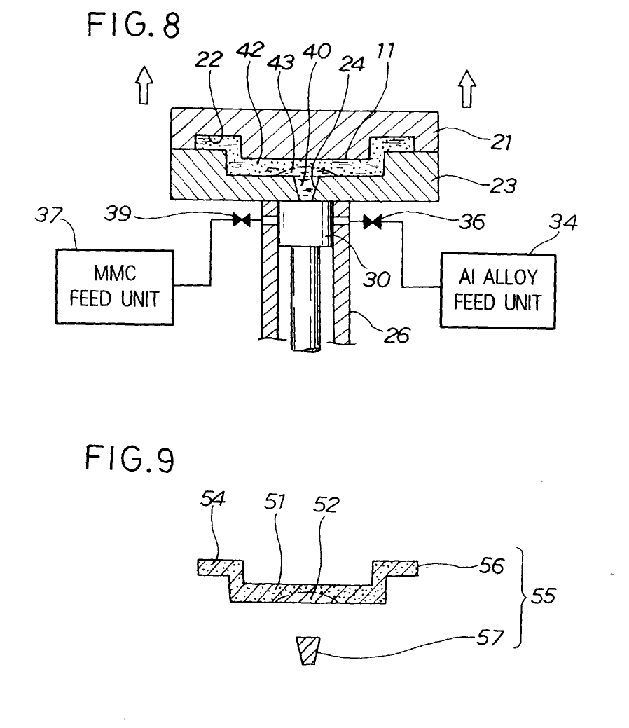

Subsequently, the piston 30 is moved upward until it arrives at a lower surface of the fixed die 23, as shown in FIG. 8. With this upward movement, the piston 30 forces the molten aluminum-based MMC material 42 into the die cavity 22 via the semi-solidified aluminum alloy 40. In this instance, because the quantity of aluminum alloy 40 supplied in the injection cylinder 26 is slightly greater than the cubic capacity of the gate 24, a small part of the aluminum alloy 40 moves into the die cavity 22 and then united with the aluminum-based MMC material 42 at a boundary between the aluminum-based MMC material 42 and the aluminum alloy 40.

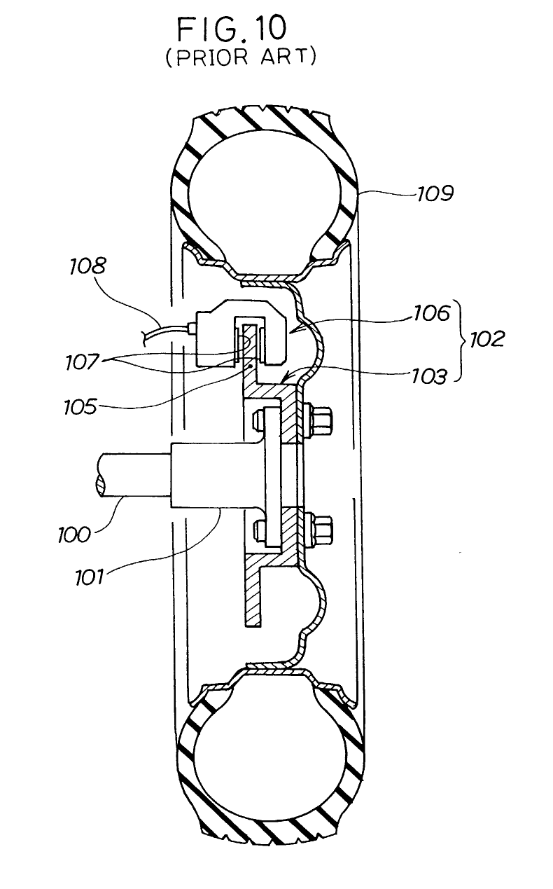

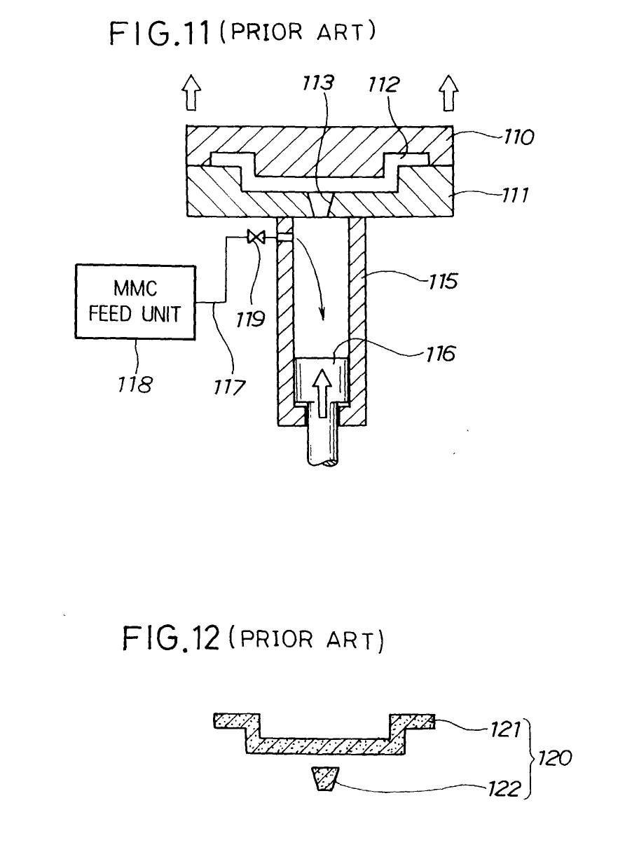

After a pre-set dwell time for solidification, the movable die 21 is moved upward away from the fixed die 23 to open the die cavity 22 and a molded article 55 (FIG. 9) is removed from the die cavity 22. The molded article 55 includes a product part (cavity portion) and a non-product part (gate portion) formed integrally with each other. The non-product part 57 is subsequently cut off or removed from the product part 56, as shown, in FIG. 9. The product part 56 is subjected to subsequent working processes through which the product part 56 is finished into a brake disc 50 shown in FIG. 7. The non-product part 57 removed from the product part 56 is formed solely of aluminum alloy, and so this part can readily-be recycled by melting it down in the aluminum alloy feed unit 34 shown in FIG. 8. With this recycling of the aluminum alloy, the manufacturing cost of the disc brake is reduced.

In the embodiments described above, the aluminum-based MMC material 42 is comprised of an aluminum alloy matrix and silicon carbide particles added in an dispersed condition to the aluminum alloy matrix as a reinforcing material. The present invention is not limited to processing of the MMC of this class and is equally applicable to other types of MMCs including a metal matrix and a reinforcing material added to the metal matrix. The term “metal matrix” as used herein encompasses metals, metal alloys and other metallic materials which can be converted in a molten or liquid state and processed in an injection molding system. Similarly, the reinforcing material may include ceramics, such as silicon carbide, aluminum oxide, aluminum nitride, magnesium oxide, silicon oxide, zirconium oxide, titanium carbide, tungsten carbide or combinations thereof. The reinforcing material may be added in the form of particles, fibers or frames. The aluminum alloy 40 may be replaced with another metal, an alloy of other metallic materials which can be processed in a semi-solidified state in the injection molding apparatus.

The molded article of the present invention should by no means be limited to brake discs as described in the illustrated embodiments but may include other articles which can be formed by injection molding. However, it is to be noted that the injection molding method of the present invention is particularly advantageous when used for forming a molded article having two parts adjoining with each other wherein one part is required to have a high mechanical strength than the other part. In such application, quantities of MMC material 42 and metal 42 to be supplied in the injection cylinder 26 are appropriately changed according to volumes of the first part (requiring a high mechanical strength) and second part (not requiring such a high mechanical strength) of a molded article to be formed.

It may be appreciated that according to the injection molding method of the present invention, a metallic material in a semi-solidified state and an MMC material in a molten state are supplied into an injection cylinder in the order named, so that these two different molding materials are separated into two layers within the injection cylinder. Thus, by merely advancing a piston toward a die cavity in a molding die, the molten MMC material is forced into the die cavity via the semi-solidified metallic material. When the quantity of supplied MMC material is set to be slightly smaller than the quantity of supplied metallic material, at least a gate of the molding die is filled with the metallic material. A gate portion (non-product part) of a molded article is cut off or removed from a cavity portion (product part). However, since the gate portion is formed solely of metallic material, it can readily be recycled by being melted down again in a feed unit of the injection molding apparatus. With this recycling of the gate portion, the overall cost of the molded article can be reduced.

In addition, a molded article, such as a brake disc, having two adjoining parts one of which is required to have a higher mechanical strength than the other part can readily be formed by appropriately changing the proportions of the MMC material and metallic material with respect the capacity of the die cavity. Due to a limited use of the MMC material which is expensive as compared to the metallic material, the molded article can be produced at a relatively low cost while maintaining a desired degree of mechanical strength which is achieved by the MMC material.

Obviously, various changes and modifications of th4e present invention are possible in the light of the above teaching. It is therefore to be noted that the invention may be practiced otherwise than as specifically described.

What is claimed is:

1. A molded article having two parts adjoining with each other, one of said two parts being required to have a higher mechanical strength than the other part, wherein said one part is formed of a metal matrix composite material, and said other part is formed of a metallic material, said metal matrix composite material and said metallic material being united together at a boundary between said two parts.

2. The molded article according to claim 1, wherein said molded article is comprised of a brake disc of a disc brake, and said one part of the molded article is an annular disc portion of said brake disc including a pad rubbing area provided for frictional engagement with a brake pad of the disc brake.

3. A method of forming a molded article on an injection molding apparatus using a metal matrix composite material, the injection molding apparatus including a molding die having a die cavity defined therein, an injection cylinder communicating with the die cavity via a gate formed in the molding die, and a piston slidably disposed inside the injection cylinder for reciprocating movement toward and away from the gate of the molding die, said method comprising the steps of:
supplying a desired quantity of metallic material in a semi-solidified state and a desired quantity of metal matrix composite material in a molten state into the injection cylinder in such a manner that said semi-solidified metallic material is situated on a piston side adjacent to the piston and said molten metal matrix composite material is situated on a gate side adjacent to the gate; and
subsequently advancing the piston toward the gate to force said molten metal matrix composite material and said semi-solidified metallic material into the die cavity in the order named, whereby the metal matrix composite and the metallic material are formed into a shape complementary in contour to the die cavity.

4. The method according to claim 3, for forming a molded article having two adjoining parts with one part having a higher mechanical strength than the other part, wherein said desired quantity of metal matrix composite material is substantially equal to a cubic volume of said one part of the molded article, and said desired quantity of metallic material is substantially equal to the sum of a cubic volume of the other part of the molded article and a cubic capacity of the gate.

5. The molded article of the method of claim 3.

6. The molded article of the method of claim 4.
